(19) United States
(12) Patent Application Publication
(10) Pub. No.: US 2025/0315324 A1
(43) Pub. Date: Oct. 9, 2025

(54) SMART APPLICATION PROGRAMMING INTERFACE (API) GENERATION AND RESOURCE MANAGEMENT IN A DISTRIBUTED SERVICE PLATFORM

(71) Applicant: Dell Products L.P., Round Rock, TX (US)

(72) Inventors: CHING-YUN CHAO, Austin, TX (US); MUZHAR S. KHOKHAR, Shrewsbury, MA (US)

(21) Appl. No.: 18/625,534

(22) Filed: Apr. 3, 2024

(51) Int. Cl. G06F 9/54

(52) U.S. Cl. CPC G06F 9/547

(57) ABSTRACT

Methods and systems for managing data, resources, services, or the like in a distributed service system (e.g., a distributed service platform) are disclosed. Application programming interface (API) requests (e.g., API calls) may be automatically generated from user intents detected in natural language statements provided by a user. Resource providers within the distributed service platforms that the user intended for the API requests to be transmitted to are also automatically identified based on the user intents. One or more resource proxies may then automatically route the generated API requests to these resource providers using a directory of the distributed service platform.

### FIELD

Embodiments disclosed herein relate generally to resource management. More particularly, embodiments disclosed herein relate to systems and methods to manage resources across shared infrastructure.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIG. 1 shows a block diagram illustrating a system in accordance with an embodiment.

FIG. 2 shows a data flow diagram in accordance with an embodiment.

FIG. 3 shows a flow chart illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing resources in a distributed service platform (also referred to herein as “distributed service system”). To provide various computer implemented services, resources within the distributed service platform have to be easily accessible to one or more users using (e.g., subscribed to) the distributed service platform.

To facilitate resource management and access in a distributed service system, application programming interfaces (APIs) may be utilized. The APIs may be Representational State Transfer (REST) APIs that facilitate stateless distribution of information through invocation of functions of the REST APIs. To read data, for example, a function may be invoked, and a uniform resource identifier (URI) may be provided. The invoked function and URI may enable the REST API to identify relevant data and provide the relevant data in response to the request.

However, creation of these APIs may be difficult for users who are not completely familiar with the architecture and components hosted within the distributed service platform. In particular, distributed service platforms may usually be organized using a federated architecture having a hierarchical structure where resources/resource providers are categorized under services/offers provided by the distributed service platform. For example, within a corporation or business, the first level within the distributed service platform may show services categorized based on the different teams (e.g., a business team, an information technology (IT) team) within the corporation or business (or services categorized based on customers of the corporation or business). In this non-limiting example, a top-level hierarchy may include two services such as “business team service” and “IT team service.”

Resources/resource providers associated with each of these two services are then linked (at a lower hierarchical level) to these services. These resources/resource providers may be of the same resource type (e.g., a storage, a storage system, a storage array, a node, a host, or the like). Namely, each of the “business team service” and the “IT team service” may be linked to various “storage systems” (e.g., a specific resource type) that each have a unique name. As a result, it would be difficult for a user of the distributed service platform (e.g., an employee and/or customer of the corporation or business) to know all of the unique names of the various available “storage systems” that the user is permitted (e.g., allowed) to access. For example, a customer of the “business team service” may only be given the name of one of the multiple “storage systems” available under the “business team service” while having permission to access other “storage systems” under the “business team service.” This customer may also have no information at all on any of the other “storage systems” available under the “IT team service” but has permission to access at least one of these other “storage systems” available under the “IT team service.”

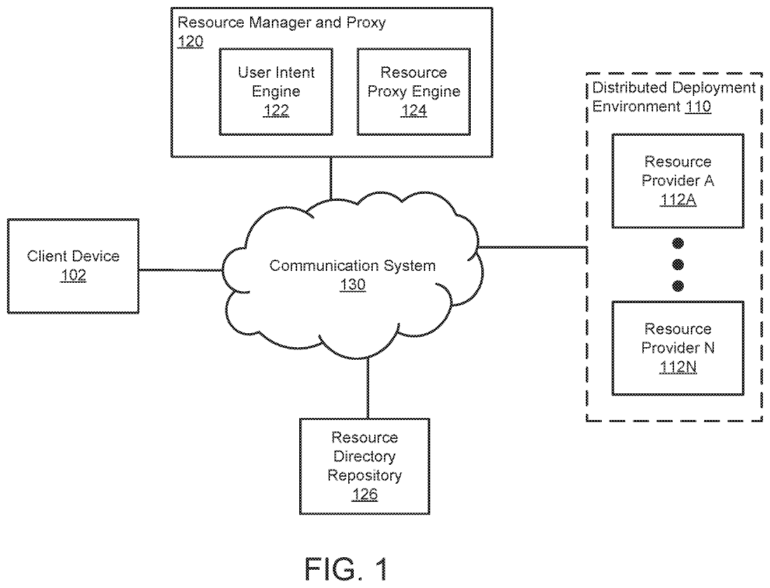

When such a user wishes to execute one or more actions (e.g., a Hypertext Transfer Protocol (HTTP) method (e.g., GET, POST, PUT, PATCH, DELETE, or the like)) via an API request within the distributed service platform, it would be difficult for this user to generate an accurate and complete API request (namely, an accurate and complete URI to include within the API request) listing all “storage systems” to which the user has access within the distributed service platform. In particular, a computing device (e.g., the client device discussed below in reference to FIG. 1) used by this user may not have (e.g., through internally/locally stored data, authorization to access network devices, or the like) all of the information this user needs to generate an accurate and complete API request that would satisfy all of this user's intentions.

As one non-limiting example, a user of a distributed service platform may want to create (e.g., POST) instances of a resource in all “storage systems” available to the user within the distributed service platform. Creation of such an API request would be very difficult (in fact almost impossible) if this user is not completely familiar with the entirety of the distributed service platform (and if the user does not have access to all relevant information that could help the user become familiar with the distributed service platform).

Consequently, such limitations make it difficult for users to use distributed service platforms without any experience or knowledge about the distributed service platforms. Thus, a better, more improved, way of creating API requests and management of the resources of within the distributed service platform is required.

To provide such an improved method, a user's resource request (e.g., a request by a user to execute one or more actions via an API request within the distributed service platform) may be obtained as a natural language statement (e.g., “I want to get all my data stored in storage systems”). The natural language statement may be parsed to obtain a user's intent (e.g., “get all data from storage systems”). The user's intent may then be used, in conjunction with one or more API request templates stored in an API request template repository and information regarding a user's subscription (e.g., private, personal, company-internal subscription, or the like) to the distributed service platform, to transform the user's resource request into an accurate and complete API request (e.g., a REST API request) for fulfilling the user's resource request.

The API request generated from the user's resource request may contain a short-form URI that only include a specific resource type (e.g., or any other attribute/parameters such as resource identifier (ID), resource name, offer ID, or the like). A resource proxy (e.g., for each available resource type (or any of the other attributes/parameters) in the distributed service platform and/or for the entire distributed service platform in general) may then forward the API requests to the accurate resource providers associated with that resource type (or any of the other attributes/parameters) using endpoint data (e.g., resource type endpoint data, or the like based on the selected attribute/parameter) stored in a resource directory repository having information of the entire structure, make up, and/or layout of the distributed service platform.

Thus, embodiments disclosed herein may address, among others, the above-discussed technical problems and difficulties associated with distributed service platforms. Namely, anyone having access to a distributed service platform may now be able to generate and guarantee accurate execution of accurate and complete API requests with little to know experience of using such a distributed service platform. Embodiments disclosed herein may also advantageously allow even advanced and/or experienced users of a distributed service platform to use the distributed service platform with improved ease and convenience.

Embodiments disclosed herein may also address limited computing resources within the distributed service platforms. In particular, the limited computing resources of the distributed system may be preferentially used to complete accurate and complete API requests instead wasting the limited computing resources on identifying and fixing erroneously created and/or routed API requests, which results in a direct technical improvement in the use and management of the computing devices' (e.g., the computing devices making up the distributed service platforms computing resources).

In an embodiment, a method for managing resources is a distributed service platform (e.g., a distributed service system) is provided. The method may include: obtaining a user resource request, the user resource request being in a natural language statement form; parsing the user resource request to obtain a user intent, the user intent specifying a distributed service platform attribute; transforming the user resource request into an application programming interface (API) request that comprises a uniform resource identifier (URI), the URI including the distributed service platform attribute; using the distributed service platform attribute included in the URI to obtain endpoint location data from a resource directory repository; and providing the API request to one or more resource providers within the distributed service system that are associated with the obtained endpoint location data for the API request to be serviced by the one or more resource providers.

The API request is a Representational State Transfer (REST) API request, the URI is a short-form URI, and information included in a request body of the API is also used, in addition to the distributed service platform attribute included in the URI, to obtain the endpoint location data from the resource directory repository.

The one or more resource providers within the distributed service system are organized in a federated architecture comprising a first hierarchical level representing services provided by the distributed service system and a second hierarchical level representing the one or more resource providers, the second hierarchical level being lower than the first hierarchical level.

The endpoint location data comprises a host name and a port number of each of the one or more resource providers to which the API request is to be provided, the one or more resource providers to which the API request is to be provided is based on the distributed service platform attribute. Providing the API request to the one or more resource providers within the distributed service system that are associated with the obtained endpoint location data may include, for a resource provider among the one or more resource providers: updating the host name of the resource provider to the URI included in the API request to obtain an updated URI; and forwarding the API request to the resource provider of the one or more resource providers using the updated URI.

The user resource request did not include the host name and the port number of each of the one or more resource providers to which the API request is to be provided.

The user resource request is received from a client device associated with a user having a subscription to the distributed service system, the subscription indicating which of the one or more resource providers the user is allowed to access. Providing the API request to the one or more resource providers within the distributed service system comprises providing the API request to all of the one or more resource providers within the distributed service system that the user is allowed to access based on the subscription.

The user resource request is transformed into the API request using the subscription and one or more API request templates stored in an API request template repository.

In an embodiment, a non-transitory media is provided. The non-transitory media may include instructions that when executed by a processor cause the computer-implemented method to be performed.

In an embodiment, a data processing system is provided. The data processing system may include the non-transitory media and a processor, and may perform the computer-implemented method when the computer instructions are executed by the processor.

Turning to FIG. 1, a block diagram illustrating a system in accordance with an embodiment is shown. The system shown in FIG. 1 may provide computer-implemented services. The computer implemented services may include any type and quantity of computer implemented services. For example, the computer implemented services may include data storage services, instant messaging services, database services, and/or any other type of service that may be implemented with a computing device.

To provide the computer implemented services, workloads may be performed by various components of the system. To perform the workloads, various information may need to be obtained. Similarly, when workloads are performed various types of new information may become available for use.

The information (e.g., resources) used in the workloads may be available from various devices of the system. To facilitate management of this information, any of the devices of the system may host instances of application programming interfaces (APIs). The APIs may be used by other devices and/or applications (e.g., hosted by other or the same device) to obtain data that may include information usable in workloads. APIs may also be used to set, change, and/or configure data (e.g., write to one or more services and/or resource providers).

To facilitate ease of use, any of the APIs may be implemented as Representational State Transfer (REST) APIs. The REST APIs may associate uniform resource identifiers (URIs) with various resources (e.g., data sources). The resources may have various properties corresponding to different types of data available via the REST APIs. The data may be stored in a database which the REST APIs may receive when requests directed to the URIs are received.

For example, to utilize a REST API, a data consumer may generate a request that includes a URI. Once sent to a data source hosting the REST API, the request may be interpreted by identifying the resources specified by the URI, and obtaining (or execution one or more other actions such as to set, change, and/or configure data (e.g., write to one or more services and/or data sources)) corresponding data from a database. The data may be returned to service the request. If no properties are specified, then properties of the resource may be returned (similarly, if a property is not associated with data, then sub-properties of the property may be returned to enable a data consumer to identify properties relevant for use).

To provide for the above noted functionality, the system of FIG. 1 may include client device 102, distributed deployment environment 110, resource manager and proxy 120 (having user intent engine 122 and resource proxy engine 124), resource directory repository 126, and communication system 130. Each of these components is discussed below.

Client device 102 may provide desired computer implemented services. To provide the computer implemented services, the client device may utilize information (e.g., data, services, resources, or the like) maintained by the distributed deployment environment 110. To do so, the client device 102 may (i) invoke REST APIs hosted by distributed deployment environment 110 to obtain data, services, and/or resources, and (ii) use the obtained data, services, and/or resources to provide the computer implemented services.

Distributed deployment environment 110 may provide access to information used in the computer implemented services (e.g., distributed deployment environment 110 may be configured as a distributed service platform). To do so, distributed deployment environment 110 may host REST APIs, databases, and/or other data structures usable to store and provide access to stored information. Additionally, distributed deployment environment 110 may include custom resource creation functionality through which custom resources may be established and used by other devices to access data maintained by distributed deployment environment 110.

To provide its functionality, distributed deployment environment 110 may include any number of resource providers (e.g., 112A-112N). The resource providers may provide access to information (e.g., data, services, resources, or the like) cooperatively or individually. The distributed deployment environment 110 may be configured to have a federated architecture.

For example, the federated architecture may have a hierarchical structure where resources/resource providers are categorized under services/offers provided by the distributed deployment environment 110. More specifically, within a corporation or business, the first level within the distributed deployment environment 110 may show services categorized based on the different teams (e.g., a business team, an information technology (IT) team) within the corporation or business (or services categorized based on customers of the corporation or business). In this non-limiting example, a top-level hierarchy may include two services such as “business team service” and “IT team service.”

Resources/resource providers associated with each of these two services are then linked (at a lower hierarchical level) to these services. These resources/resource providers may be of the same resource type (e.g., a storage, a storage system, a storage array, a node, a host). Namely, each of the “business team service” and the “IT team service” may be linked to various “storage systems” (e.g., a specific resource type) that each have a unique name (e.g., names based on naming schemes created by each team).

To more accurately generate and route requests (e.g., resource requests associated with API requests such as REST API requests) received from the client device 102 to a desired endpoint (e.g., a desired service provider among service providers 112A-112N), the system of FIG. 1 may include a resource manager and proxy 120 having a user intent engine 122 and a resource proxy engine 124.

Each of the user intent engine 122 and the resource proxy engine 124 may be configured as part of (e.g., installed, hosted, or the like within) the resource manager and proxy 120. Each of the user intent engine 122 and the resource proxy engine 124 may be implemented using hardware, software, or a combination thereof.

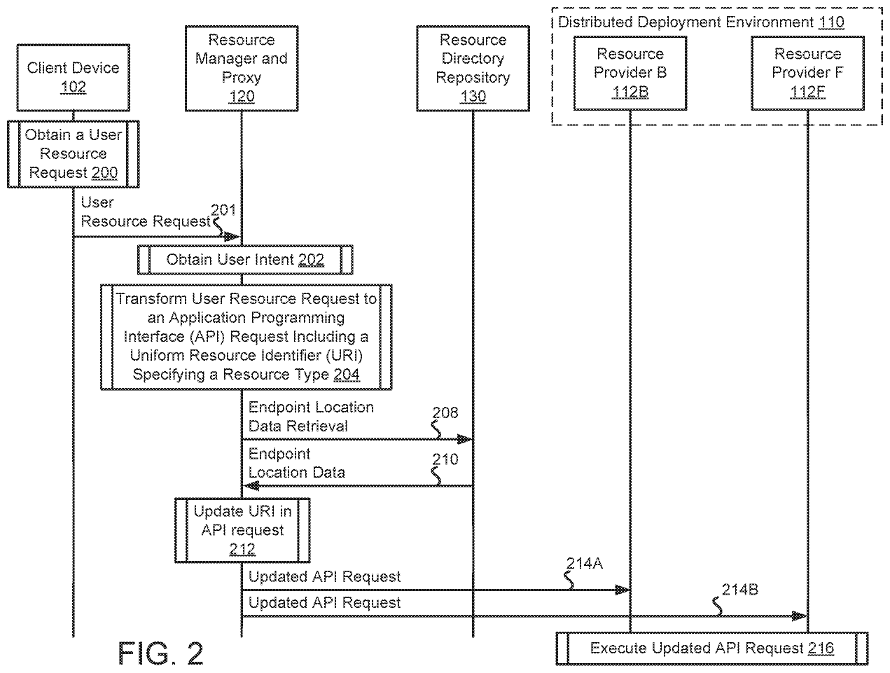

The user intent engine 122 may be configured to parse and transform a resource request received from the client device 102 into an API request. This will be discussed in more detail below in reference to FIG. 2.

The resource proxy engine 124 may be configured to forward (e.g., route) the API request(s) generated by the user intent engine 122 to intended ones of the resource providers 112A-112N (for the API requests to be fulfilled (e.g., executed) by the receiving resource providers 112A-112N). For example, the resource proxy engine 124 may use (e.g., obtain) information stored in the resource directly repository 126 to route requests received from the client infrastructure to one or more of the resource providers 112A-112N for servicing of the requests received from the client device 102. Additional details regarding the forwarding of the API requests by the resource proxy engine 124 will be discussed below in reference to FIG. 2.

The resource directory repository 126 may be configured to store information regarding (e.g., in the form of a directory of) the resource providers 112A-112N. This information may be stored in any form and/or format (e.g., a list, a table, a document, a text file, or the like). The information may include what (e.g., data, services, resources, resource types, or the like) each resource provider 112A-112N is able to provide along with information about the resource provider 112A-112N itself (e.g., a host name of the resource provider, a port number of the resource provider, or the like).

Although FIG. 1 shows the user intent engine 122 and the resource proxy engine 124 as being components of the resource manager and proxy 120, each of the user intent engine 122 and the resource proxy engine 124 may be its own separate and independent component within the system of FIG. 1 (e.g., as not being a component within the resource manager and proxy 120).

Additionally, the system of FIG. 1 may have a single resource proxy engine 124 for all resource providers 112A-112N of the distributed deployment environment 110. Alternatively or in addition to the above, the system of FIG. 1 may have multiple ones of the resource proxy engine 124. In this example with multiple resource proxy engines 124, each resource proxy engine 124 may be associated with one or more attributes/parameters (e.g., a resource type, a resource name, a resource identifier (ID), an offer ID, an offer type, a service ID, or the like) associated with the services, offers, and resources provided by the distributed deployment environment 110. As one non-limiting example, assume that the distributed deployment environment 110 hosts various resource types (e.g., a storage, a storage system, a storage array, a node, a host, or the like), a resource proxy engine 124 may be instantiated for each of these resource types for routing API requests to each resource type.

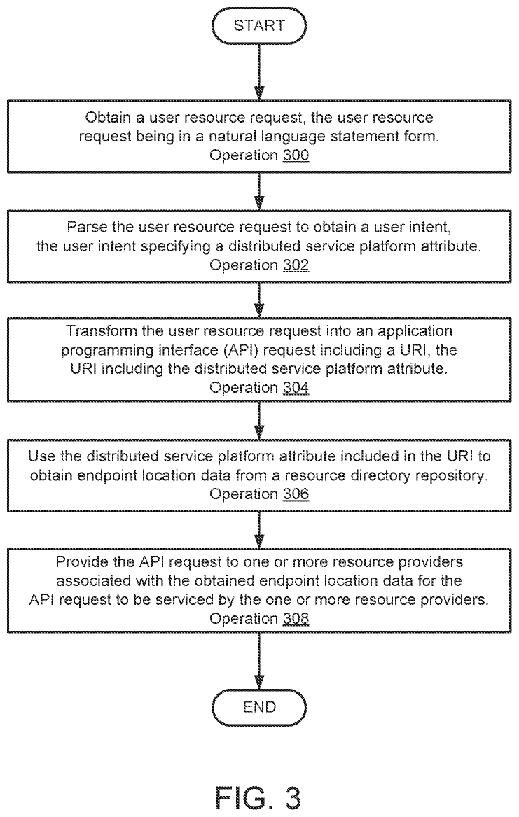

When providing their functionality, any of the components shown in the system of FIG. 1 (and/or a portion thereof) may perform the flows and methods illustrated in FIGS. 2-3.

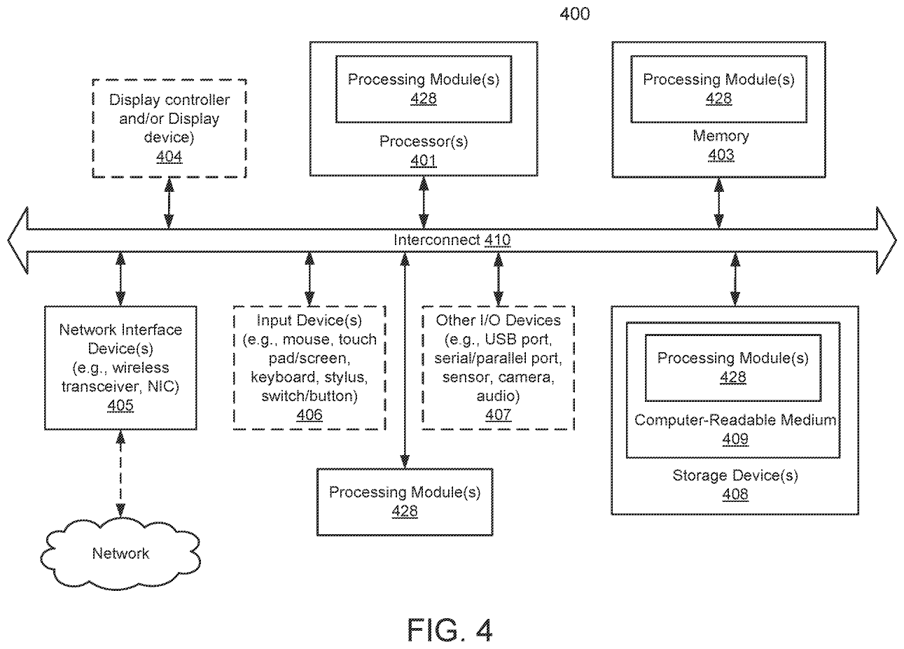

Each of the client device 102, the resource providers 112A-112N, the resource manager and proxy 120, the user intent engine 122 (as a component and/or device separate and independent from the resource manager and proxy 120), the resource proxy engine 124 (as a component and/or device separate and independent from the resource manager and proxy 120), and the resource directory repository, may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

In embodiments, the user intent engine 122 and resource proxy engine 124 may also be implanted as hardware, software, or a combination of both as part of the resource manager and proxy 120 and/or as part of each resource provider 112A-112N and the client device 102. For example, an instance of the resource proxy engine 124 (and/or an instance of the user intent engine 122) may be installed in each of the resource providers 112A-112N and/or in the client device 102.

Additionally, although resource directory repository 126 is being shown as a separate and independent component (e.g., computing device) in the system of FIG. 1, the resource directory repository 126 may also be configured as a database stored in physical and/or virtual memory hosted (e.g., included, installed, or the like) in each of the client device 102, the resource proxy engine 124, and/or one or all of the resource providers 112A-112N.

Any of the components illustrated in FIG. 1 may be operably connected to each other (and/or components not illustrated) with communication system 130. In an embodiment, communication system 130 includes one or more networks that facilitate communication between any number of components. The networks may include wired networks and/or wireless networks (e.g., and/or the Internet). The networks may operate in accordance with any number and types of communication protocols (e.g., such as the internet protocol).

While illustrated in FIG. 1 as including a limited number of specific components, a system in accordance with an embodiment may include fewer, additional, and/or different components than those illustrated therein.

To further clarify embodiments disclosed herein, a data flow diagram in accordance with an embodiment is shown in FIG. 2. The data flow diagram may illustrate a distributed service platform directed resource management process to be performed within a system similar to system of FIG. 1. As discussed in FIG. 1, all of the components shown may be connected to one another via communication system 130, allowing the systems and/or devices to communicate and exchange information with one another.

Turning to FIG. 2, in Operation 200, a client device 102 may obtain a user resource request from a user of the client device. The user resource request may be obtained in a natural language statement form, and include terms and phrases connected to one or more actions that the user wishes to perform using the distributed deployment environment 110 (e.g., via one or more API requests). As one non-limiting example, the user resource request may be “fetch me all resources in the distributed deployment environment that belong to me.” As another non-limiting example, the user resource request may be “store the file named X stored on my desktop to all storage systems in the distributed deployment environment.” As yet another non-limiting example, the user resource request may be “I want to retrieve all my resources from storage systems in the distributed service platform.”

In embodiments, the user resource request may include one or more keywords that match one or more of the one or more attributes/parameters (e.g., a resource type, a resource name, a resource identifier (ID), an offer ID, an offer type, a service ID, or the like) associated with the services, offers, and resources provided by the distributed deployment environment 110 (also referred to herein as “distributed service platform attribute”). For example, the above example resource request of “I want to retrieve all my resources from storage systems in the distributed service platform,” includes the resource type “storage systems.”

As discussed in more detail below, the keywords included in the user resource request may affect: (i) the type of API request (namely, the URI in the API request) generated; (ii) how the generated API request is routed (e.g., forwarded) by the resource manager and proxy 120 (namely, the resource proxy engine 124 of the resource manager and proxy 120); and (iii), in a system with multiple ones of the resource proxy engine 124, which of the resource proxy engines 124 will be doing the routing (e.g., forwarding).

In embodiments, the user resource request may be received from the user (e.g., by the client device 102) in any way or form. For example, the user may type the request into a graphical user interface (GUI) displayed on a display of the client device 102, the user may upload a document or file including the user resource request through the GUI, or the like.

In Operation 201, the client device 102 transmits the user resource request to the resource manager and proxy 120 (namely, the user intent engine 122 of the resource manager and proxy 120 that is not shown in FIG. 2). Any type of transmission protocol and/or method may be used by the client device 102 to transmit the user resource request to the resource manager and proxy 120.

In Operation 202, the resource manager and proxy 120 (namely through using the user intent engine 122) may obtain user intent from the user resource request. To obtain the user intent from the user resource request, the user resource request may be parsed (e.g., by the user intent engine 122) using any type, number, and combination of natural language processing (NLP) techniques.

In Operation 204, the user resource request may be transformed into an API request (e.g., a REST API request) including a uniform resource identifier (URI). In this example described in FIG. 2, the URI may also include (e.g., specify, indicate, or the like) one or more resource types. However, one or ordinary skill will appreciate that the URI can include any of the other above-discussed attributes/parameters (e.g., a resource type, a resource name, a resource identifier (ID), an offer ID, an offer type, a service ID, or the like) without departing from the scope of embodiments disclosed herein.

The user resource request may be transformed (e.g., by the user intent engine 122 of the resource manager and proxy 120) using one or more API request templates stored in an API request template repository (e.g., in the form of a database/data structure similar to the resource directory repository 126 of FIG. 1). As a non-limiting example, keywords retrieved from and/or generated using intents conveyed through the natural language statement(s) in the user resource request may be used to select at least one of the API request templates and fill in one or more blank parameters within the selected API request template. Other techniques for automatically transforming keywords and intents detected in and/or generated from natural language statements into API requests using one or more API request templates may also be used without departing from the scope of embodiments disclosed herein.

In embodiments, information related to a user's subscription (e.g., private, personal, company-internal subscription, or the like) to the distributed deployment environment 110 may also be used. The user subscription may indicate (e.g., specify) which resource providers 112A-112N within the distributed deployment environment 110 the user has authorization (e.g., permission) to access.

The API request template repository may be stored in the resource manager and proxy 120. Alternatively, the API request template repository may be a separate and independent remote storage device that is also connected to the communication system 130 of FIG. 1.

In embodiments, any missing and/or incomplete information in the user resource request may automatically be supplied by the user intent engine 122 using one or more default rules and/or policies established by an administrator and/or provider of the distributed deployment environment 110. In the event that the user intent engine 122 is unable to supply the and/or incomplete information using the one or more default rules and/or policies, the user intent engine 122 will alert the user (through instructing client device 102 to display an error notification, or the like) that the user resource request contains missing and/or incomplete information.

In embodiments, the URI in the generated API request may be a short-form URI that does not include a specific path to one or more resource providers of the distributed deployment environment 110. The short-form URI may include the bare minimum information required such as: (i) at least one HTTP method; one of the above-discussed attributes/parameters (e.g., a resource type, a resource name, a resource identifier (ID), an offer ID, an offer type, a service ID, or the like); and a request body including actual data that is necessary to create, update, or delete a resource.

Using the above example user resource request of “I want to retrieve all my resources from storage systems in the distributed service platform,” as a non-limiting example, an example URI generated for this user resource request may look like “GET /rest/services/v1/storage-systems” (or something similar based on the settings, setup, and/or configurations of the distributed deployment environment 110). In this non-limiting example, a specific resource type (the storage systems) is specifically called out by the API request.

In Operation 208 and Operation 210, a request to retrieve endpoint location data associated with one or more resource providers 112A-112N of the distributed deployment environment 110 (from resource directory repository 126) may be initiated by the resource manager and proxy 120 (namely, by the resource proxy engine 124 of the resource manager and proxy 120). This retrieval request may be initiated based on receipt of the API request generated in Operation 204 by the resource proxy engine 124. In embodiments, the resource proxy engine 124 may directly access the data stored in the resource directory repository 126 without sending the retrieval request.

In embodiments, if the system includes only a single resource proxy engine 124 that services the entirety of the distributed deployment environment 110, the resource proxy engine 124 will parse through the URI to look for keywords that would help the resource proxy engine 124 obtain the necessary one (or ones) of the endpoint location data from the resource directory repository 126. In embodiments, any of the information included in the request body of the API request may also be used as additional context for narrowing down to one or more specific resource providers for servicing the API request.

Using the above example URI of “GET/rest/services/v1/storage-systems,” as a non-limiting example, the resource proxy engine 124 may look for all resource providers stored in the directory hosted by the resource directory repository 126 that supports the “GET” function, is associated with the resource type of “storage systems”, and includes the resource name or resource ID of the resource belonging the user.

Based on information included in the user's subscription to the distributed deployment environment 110, the resource proxy engine 124 may also narrow down (e.g., eliminate all resource providers the user is not authorized to access) the number of resource providers that are able to service the API request. This step of eliminating the narrowing down the resource providers the user is not authorized to access may also be done after all resource providers associated the specific resource type (or any other attribute/parameter) is retrieved and/or identified.

The endpoint location data may include a host name and a port number of each of the one or more resource providers to which the API request is to be provided.

In embodiments, if the system includes multiple ones of the resource proxy engine 124, the generated API request may be provided (by the user intent engine 122) to one or more specific resource proxy engine 124 associated with one of the attributes/parameters (e.g., a resource type, a resource name, a resource identifier (ID), an offer ID, an offer type, a service ID, or the like) included in the URI. As a non-limiting example, assume that the URI includes resource type A. In this example, the generated API request may be provided to a resource proxy engine 124 specifically instantiated and configured for resource type A. In embodiments, any of the information included in the request body of the API request may also be used as additional context for narrowing down to one or more specific resource proxy engines 124 for forwarding of the API request.

The specific resource proxy engine(s) 124 that receive the generated API request may then execute above-discussed Operations 208 and 210 to retrieve the endpoint location data. Alternatively, each of these resource proxy engine(s) 124 may already be configured (and continuously updated by, for example, resource directory repository 126 or any of the resource providers 112A-112N of the distributed deployment environment 110) to know which resource providers are associated with the attributes/parameters (e.g., a resource type, a resource name, a resource identifier (ID), an offer ID, an offer type, a service ID, or the like) that each of these resource proxy engine(s) 124 are configured for. Thus, the resource proxy engine(s) 124 may not need to directly access resource directory repository 126 to obtain the endpoint location data.

In Operation 212, once the endpoint location data has been obtained (e.g., by the resource proxy engine 124) the resource proxy engine 124 updates the URI in the API request to include the endpoint location data.

This may include updating (e.g., adding, replacing, or the like) one or more parameters of the URI (e.g., a temporary host name, a generic host name, or the like) with the exact host name and/or port number of the specific resource provider(s) (e.g., 112B and 112F) to which the API request is to be routed (e.g., forwarded) to obtain an updated API request (namely an updated URI in the API request). If the API request is to be routed to multiple resources (e.g., as in the example shown in FIG. 2), then additional copies (e.g., instances) of the API request may be generated for each of the multiple resource providers.

In Operations 214A and 214B, the updated API request(s) that includes the updated URI(s) are routed to the respective resource providers (here resource provider B 112B and resource provider F 112F of resource providers 112A-112N in FIG. 2).

In Operation 216, the resource provider(s) that receive the API request(s) execute the API request(s) to fulfil the user resource request initially obtained by the client device 102. Said another way, the updated service API request(s) are fulfilled using the instance of the API hosted by the receiving resource provider(s). Once the updated service API request is fulfilled, the requested services are provided by the receiving resource provider(s) back to the client device 102 to complete the user resource request obtained by the client device 102.

As discussed above, the components of FIG. 1 may perform various methods to manage operation of data processing systems. FIG. 3 illustrates a method that may be performed by the components of the system of FIG. 1. In the diagram discussed below and shown in FIG. 3, any of the operations may be repeated, performed in different orders, and/or performed in parallel with or in a partially overlapping in time manner with other operations.

Turning to FIG. 3, a flow diagram illustrating a method for managing resources in a distributed service platform in accordance with an embodiment is shown. The method may be performed by any of the components shown in FIG. 1.

At operation 300, as discussed above in reference to FIG. 2, a user resource request may be obtained by a resource manager and proxy 120. More specifically, the user resource request may be obtained by a user intent engine 122 of the resource manager and proxy 120.

At operation 302, as discussed above in reference to FIG. 2, the user resource request is parsed to obtain a user intent. The user intent specifies a distributed service platform attribute (e.g., the one or more attributes/parameters (e.g., a resource type, a resource name, a resource identifier (ID), an offer ID, an offer type, a service ID, or the like) associated with the services, offers, and resources provided by the distributed deployment environment 110).

At operation 304, as discussed above in reference to FIG. 2, the user resource request is transformed (e.g., by the user intent engine 122 of the resource manager and proxy 120), into an API request including a URI. The URI includes the distributed service platform attribute. The URI may also include any of the above information discussed above in reference to FIG. 2.

At operation 306, as discussed above in reference to FIG. 2, the distributed service platform attribute included in the URI is used (e.g., by a resource proxy engine 124 of the resource manager and proxy 120) to obtain endpoint location data from a resource directory repository. The endpoint location data may be obtained in any of the ways discussed above in reference to FIG. 2.

At operation 308, as discussed above in reference to FIG. 2, the API request is provided (e.g., routed, forwarded, or the like) to one or more resource providers associated with the obtained endpoint location data for the API request to be serviced by the one or more service providers.

Providing the API request to the one or more resource providers within the distributed service system that are associated with the obtained endpoint location data may include, for a resource provider among the one or more resource providers: updating (e.g., adding and/or replacing as discussed above in reference to FIG. 2) the host name of the resource provider to the URI included in the API request to obtain an updated URI; and forwarding or routing the API request to the resource provider of the one or more resource providers using the updated URI.

The API request(s) are fulfilled using the instance of the API hosted by the receiving resource provider(s). Once the API request(s) are fulfilled, the requested services are provided by the receiving resource provider(s) that fulfilled the API request(s) back to the client device 102 to complete the user resource request obtained from the client device 102 in above Operation 300.

The method may end following operation 308.

Any of the components illustrated in FIGS. 1-3 may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

What is claimed is:

1. A method for managing resources in a distributed service system, the method comprising:
obtaining a user resource request, the user resource request being in a natural language statement form;
parsing the user resource request to obtain a user intent, the user intent specifying a distributed service platform attribute;
transforming the user resource request into an application programming interface (API) request that comprises a uniform resource identifier (URI), the URI including the distributed service platform attribute;
using the distributed service platform attribute included in the URI to obtain endpoint location data from a resource directory repository; and
providing the API request to one or more resource providers within the distributed service system that are associated with the obtained endpoint location data for the API request to be serviced by the one or more resource providers.

2. The method of claim 1, wherein the API request is a Representational State Transfer (REST) API request, the URI is a short-form URI, and information included in a request body of the API is also used, in addition to the distributed service platform attribute included in the URI, to obtained the endpoint location data from the resource directory repository.

3. The method of claim 2, wherein the one or more resource providers within the distributed service system are organized in a federated architecture comprising a first hierarchical level representing services provided by the distributed service system and a second hierarchical level representing the one or more resource providers, the second hierarchical level being lower than the first hierarchical level.

4. The method of claim 3, wherein
the endpoint location data comprises a host name and a port number of each of the one or more resource providers to which the API request is to be provided, the one or more resource providers to which the API request is to be provided is based on the distributed service platform attribute, and
providing the API request to the one or more resource providers within the distributed service system that are associated with the obtained endpoint location data comprises, for a resource provider among the one or more resource providers:
updating the host name of the resource provider to the URI included in the API request to obtain an updated URI; and
forwarding the API request to the resource provider of the one or more resource providers using the updated URI.

5. The method of claim 4, wherein the user resource request did not include the host name and the port number of each of the one or more resource providers to which the API request is to be provided.

6. The method of claim 1, wherein
the user resource request is received from a client device associated with a user having a subscription to the distributed service system, the subscription indicating which of the one or more resource providers the user is allowed to access, and
providing the API request to the one or more resource providers within the distributed service system comprises providing the API request to all of the one or more resource providers within the distributed service system that the user is allowed to access based on the subscription.

7. The method of claim 6, wherein the user resource request is transformed into the API request using the subscription and one or more API request templates stored in an API request template repository.

8. A non-transitory machine-readable medium having instructions stored therein, which when executed by a processor, cause the processor to perform operations for managing resources in a distributed service system, the operations comprising:
obtaining a user resource request, the user resource request being in a natural language statement form;
parsing the user resource request to obtain a user intent, the user intent specifying a distributed service platform attribute;
transforming the user resource request into an application programming interface (API) request that comprises a uniform resource identifier (URI), the URI including the distributed service platform attribute;
using the distributed service platform attribute included in the URI to obtain endpoint location data from a resource directory repository; and
providing the API request to one or more resource providers within the distributed service system that are associated with the obtained endpoint location data for the API request to be serviced by the one or more resource providers.

9. The non-transitory machine-readable medium of claim 8, wherein the API request is a Representational State Transfer (REST) API request, the URI is a short-form URI, and information included in a request body of the API is also used, in addition to the distributed service platform attribute included in the URI, to obtained the endpoint location data from the resource directory repository.

10. The non-transitory machine-readable medium of claim 9, wherein the one or more resource providers within the distributed service system are organized in a federated architecture comprising a first hierarchical level representing services provided by the distributed service system and a second hierarchical level representing the one or more resource providers, the second hierarchical level being lower than the first hierarchical level.

11. The non-transitory machine-readable medium of claim 10, wherein
the endpoint location data comprises a host name and a port number of each of the one or more resource providers to which the API request is to be provided, the one or more resource providers to which the API request is to be provided is based on the distributed service platform attribute, and
providing the API request to the one or more resource providers within the distributed service system that are associated with the obtained endpoint location data comprises, for a resource provider among the one or more resource providers:
updating the host name of the resource provider to the URI included in the API request to obtain an updated URI; and
forwarding the API request to the resource provider of the one or more resource providers using the updated URI.

12. The non-transitory machine-readable medium of claim 11, wherein the user resource request did not include the host name and the port number of each of the one or more resource providers to which the API request is to be provided.

13. The non-transitory machine-readable medium of claim 8, wherein
the user resource request is received from a client device associated with a user having a subscription to the distributed service system, the subscription indicating which of the one or more resource providers the user is allowed to access, and
providing the API request to the one or more resource providers within the distributed service system comprises providing the API request to all of the one or more resource providers within the distributed service system that the user is allowed to access based on the subscription.

14. The non-transitory machine-readable medium of claim 13, wherein the user resource request is transformed into the API request using the subscription and one or more API request templates stored in an API request template repository.

15. A data processing system comprising:
a processor; and
a memory, wherein the memory stores instructions that when executed by a processor cause the processor to perform operations for managing resources in a distributed service system, the operations comprising:
obtaining a user resource request, the user resource request being in a natural language statement form;
parsing the user resource request to obtain a user intent, the user intent specifying a distributed service platform attribute;
transforming the user resource request into an application programming interface (API) request that comprises a uniform resource identifier (URI), the URI including the distributed service platform attribute;
using the distributed service platform attribute included in the URI to obtain endpoint location data from a resource directory repository; and
providing the API request to one or more resource providers within the distributed service system that are associated with the obtained endpoint location data for the API request to be serviced by the one or more resource providers.

16. The data processing system of claim 15, wherein the API request is a Representational State Transfer (REST) API request, the URI is a short-form URI, and information included in a request body of the API is also used, in addition to the distributed service platform attribute included in the URI, to obtained the endpoint location data from the resource directory repository.

17. The data processing system of claim 16, wherein the one or more resource providers within the distributed service system are organized in a federated architecture comprising a first hierarchical level representing services provided by the distributed service system and a second hierarchical level representing the one or more resource providers, the second hierarchical level being lower than the first hierarchical level.

18. The data processing system of claim 17, wherein
the endpoint location data comprises a host name and a port number of each of the one or more resource providers to which the API request is to be provided, the one or more resource providers to which the API request is to be provided is based on the distributed service platform attribute, and
providing the API request to the one or more resource providers within the distributed service system that are associated with the obtained endpoint location data comprises, for a resource provider among the one or more resource providers:
updating the host name of the resource provider to the URI included in the API request to obtain an updated URI; and
forwarding the API request to the resource provider of the one or more resource providers using the updated URI.

19. The data processing system of claim 18, wherein the user resource request did not include the host name and the port number of each of the one or more resource providers to which the API request is to be provided.

20. The data processing system of claim 15, wherein
the user resource request is received from a client device associated with a user having a subscription to the distributed service system, the subscription indicating which of the one or more resource providers the user is allowed to access, and
providing the API request to the one or more resource providers within the distributed service system comprises providing the API request to all of the one or more resource providers within the distributed service system that the user is allowed to access based on the subscription.
